(19) United States
(12) Patent Application Publication
(10) Pub. No.: US 2021/0241321 A1
(43) Pub. Date: Aug. 5, 2021

(54) METHOD AND SYSTEM FOR REQUESTING AND TRANSMITTING MARKETING IMAGES OR VIDEO

(71) Applicant: METAIL LIMITED, London (GB)

(72) Inventors: Jim DOWNING, London (GB); Vikesh SHAH, London (GB); Yu CHEN, London (GB); Tom ADEYOOLA, London (GB)

(21) Appl. No.: 17/050,548

(22) PCT Filed: Apr. 23, 2019
(86) PCT No.: PCT/GB2019/051137

§ 371 Date: Oct. 26, 2020

(30) Foreign Application Priority Data
Apr. 24, 2018 (GB) 1806686.0

(51) Int. Cl. G06Q 30/02; H04N 5/76; G06T 7/10; G06T 3/00; G06T 11/00; H04N 7/04; H04W 4/08; H04W 4/35

(52) U.S. Cl. CPC G06Q 30/0269; H04N 5/76; G06T 7/10; G06T 3/0093; G06T 2207/10016; H04N 7/04; H04W 4/08; H04W 4/35; G06Q 30/0252; G06T 11/001

(57) ABSTRACT

Disclosed is a computer-implemented method for requesting and transmitting marketing images or video. The method includes receiving a communication from a remote terminal, identifying a user or a group of users that are associated with the received communication, identifying data associated with the identified user or the group of users, identifying goods or services using the identified data associated with the identified user or group of users, requesting marketing images or video from a marketing images or video supplying system that are relating to the identified goods or services, receiving the requested marketing images or video from the marketing images or video supplying system, and transmitting the received marketing images or video to the remote terminal.

### TECHNICAL FIELD

The present disclosure relates generally to data processing for digital merchandising; and more specifically, to computer-implemented methods for requesting and transmitting marketing images or video. the present disclosure relates to systems configured to request and transmit marketing images or video. Furthermore, the present disclosure also relates to computer program products comprising non-transitory computer-readable storage media having computer-readable instructions stored thereon, the computer-readable instructions being executable by a computerized device comprising processing hardware to execute aforementioned methods.

### BACKGROUND

In recent years, digital commerce of goods, facilitated by digital commerce platforms, has increased exponentially, owing to quick and easy access to the goods at any time and from any place. Typically, the digital commerce platforms allow consumers to purchase goods or services from the convenience of their households and get them delivered at their doorstep. Notably, the digital commerce platforms provide high quality digital images of goods so as to attract consumers thereto. Such digital images capture essential features associated with the goods thereby increasing likelihood of purchase thereof, and enhancing profitability of the digital commerce platforms.

Traditionally, on platforms related to digital commerce, a user browses through the selection of goods in a sequential manner. However, in such case, the user is able to browse and view only a small range of goods amongst the wide selection of goods offered by the digital commerce platform. Alternatively, the user may use a keyword search or a filtering criterion to find suitable goods. For example, on a digital commerce platform relating to garments, the user may use a filtering criteria ‘shirt’ and may view good matching the filtering criteria. However, such methods of viewing and performing digital commerce present the user with a multitude of unnecessary information and is inefficient in terms of time and effort of the user. Moreover, the retrieval and presentation of such unnecessary information utilizes large amounts of network bandwidth.

Furthermore, with respect to digital merchandising, goods are presented to the user using a set of images that display the goods in a variety of positionings and placements. For instance, in case of goods relating to apparels, a customer is presented with images having such apparels worn by either a model or a mannequin. Typically, the selection of the model or mannequin is done with the intension of highlighting the essential features of the apparels. Furthermore, standard sized models are selected for presenting the goods in the set of images to be displayed on the digital commerce platform. However, when the user views the set of images while browsing for goods to purchase, there is created a disconnect between the user and the images presented on the digital platform. Specifically, in case of garments, the user is unable to envision themselves wearing the garment as the model in the set of images has a substantially different body type as compared to the body type of the user. Moreover, from the images comprising the standard sized models, the user is unable to ascertain a fit of the garment on their body type. Consequently, the user has an unsatisfactory experience, thereby affecting user's engagement and lifetime value of the user with the digital commerce platform.

Therefore, in light of the foregoing discussion, there exists a need to overcome the aforementioned drawbacks associated with online digital merchandising.

### SUMMARY

The present disclosure seeks to provide a computer-implemented method for requesting and transmitting marketing images or video. The present disclosure also seeks to provide a computer program product for requesting and transmitting marketing images or video. The present disclosure also seeks to provide a system for requesting and transmitting marketing images or video. The present disclosure seeks to provide a solution to the existing problem of user being provided with non-relevant marketing images or video. An aim of the present disclosure is to provide a solution that overcomes at least partially the problems encountered in prior art, and provides an efficient technique for providing a user with relevant marketing images or video determined based on user preferences.

In a first aspect, an embodiment of the present disclosure provides a computer-implemented method for requesting and transmitting marketing images or video, the method including the steps of:

(i) receiving a communication from a remote terminal;

(ii) identifying a user, or a group of users, associated with the received communication;

(iii) identifying data associated with the identified user or group of users;

(iv) identifying goods or services, using the identified data associated with the identified user or group of users;

(v) requesting marketing images or video from a marketing images or video supplying system, relating to the identified goods or services;

(vi) receiving the requested marketing images or video from the marketing images or video supplying system; and

(vii) transmitting the received marketing images or video to the remote terminal.

In a second aspect, an embodiment of the present disclosure provides a computer program product executable on a processor to:

(i) receive a communication from a remote terminal;

(ii) identify a user, or a group of users, associated with the received communication;

(iii) identify data associated with the identified user or group of users;

(iv) identify goods or services, using the identified data associated with the identified user or group of users;

(v) request marketing images or video from a marketing images or video supplying system, relating to the identified goods or services;

(vi) receive the requested marketing images or video from the marketing images or video supplying system; and

(vii) transmit the received marketing images or video to the remote terminal.

In a third aspect, an embodiment of the present disclosure provides a system including a processor and a marketing images or video supplying system, wherein the processor is configured to:

(i) receive a communication from a remote terminal;

(ii) identify a user, or a group of users, associated with the received communication;

(iii) identify data associated with the identified user or group of users;

(iv) identify goods or services, using the identified data associated with the identified user or group of users;

(v) request marketing images or video from the marketing images or video supplying system, relating to the identified goods or services;

(vi) receive the requested marketing images or video from the marketing images or video supplying system; and

(vii) transmit the received marketing images or video to the remote terminal.

In a fourth aspect, an embodiment of the present disclosure provides a computer-implemented method for producing and managing responsive online digital merchandising, including identifying goods or services using identified data associated with an identified user in communication from a remote terminal; receiving requested marketing images or video from a marketing images or video supplying system, and transmitting the received marketing images or video to the remote terminal.

In a fifth aspect, an embodiment of the present disclosure provides a computer program product executable on a processor to perform a aforesaid method for producing and managing responsive online digital merchandising.

In a sixth aspect, an embodiment of the present disclosure provides a system for producing and managing responsive online digital merchandising, the system including a processor and a marketing images or video supplying system, the processor configured to identify goods or services using identified data associated with an identified user in communication from a remote terminal; to receive requested marketing images or video from the marketing images or video supplying system, and to transmit the received marketing images or video to the remote terminal.

In a seventh aspect, an embodiment of the present disclosure provides a computer-implemented method for requesting and displaying marketing images or video, the method including steps of:

(i) identifying a user of a terminal;

(ii) identifying data associated with the identified user;

(iii) identifying goods or services, using the identified data associated with the identified user;

(iv) requesting marketing images or video from a marketing images or video supplying system, relating to the identified goods or services;

(v) receiving the requested marketing images or video from the marketing images or video supplying system; and

(vi) displaying the received marketing images or video on the terminal.

In an eighth aspect, an embodiment of the present disclosure provides a computer program product executable on a processor to:

(i) identify a user of a terminal;

(ii) identify data associated with the identified user;

(iii) identify goods or services, using the identified data associated with the identified user;

(iv) request marketing images or video from a marketing images or video supplying system, relating to the identified goods or services;

(v) receive the requested marketing images or video from the marketing images or video supplying system; and

(vi) display the received marketing images or video on the terminal.

In a ninth aspect, an embodiment of the present disclosure provides a terminal including a processor and a marketing images or video supplying system, wherein the processor is configured to:

(i) identify a user of the terminal;

(ii) identify data associated with the identified user;

(iii) identify goods or services, using the identified data associated with the identified user;

(iv) request marketing images or video from the marketing images or video supplying system, relating to the identified goods or services;

(v) receive the requested marketing images or video from the marketing images or video supplying system; and

(vi) display the received marketing images or video on the terminal.

Embodiments of the present disclosure substantially eliminate or at least partially address the aforementioned problems in the prior art, and enables targeted and customized merchandising data of goods and services, thereby enhancing user-experience and user-engagement.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates steps of a computer-implemented method for requesting and transmitting marketing images or video, in accordance with an embodiment of the present disclosure; and

FIG. 2 illustrates block diagram of a system for requesting and transmitting marketing images or video, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, an embodiment of the present disclosure provides a computer-implemented method for requesting and transmitting marketing images or video, the method including the steps of:

(i) receiving a communication from a remote terminal;

(ii) identifying a user, or a group of users, associated with the received communication;

(iii) identifying data associated with the identified user or group of users;

(iv) identifying goods or services, using the identified data associated with the identified user or group of users;

(v) requesting marketing images or video from a marketing images or video supplying system, relating to the identified goods or services;

(vi) receiving the requested marketing images or video from the marketing images or video supplying system; and

(vii) transmitting the received marketing images or video to the remote terminal.

The present disclosure aims to provide a system and method for producing and presenting marketing images or video relating to digital commerce platforms, wherein the marketing images or video are selected based on a user of the digital commerce platform. Specifically, the present disclosure provides the user goods or services that are relevant and suitable to the user. Notably, the method and the system disclosed in the present disclosure takes into account a variety of data associated with the user to determine goods or service relevant thereto. Consequently, the present system and method do not provide the user with irrelevant results and thus, is efficient in terms of time and effort of the user. The present disclosure employs predetermined, predicted or learned criteria to determine viewing preferences of the user and provides results that comply with such viewing preferences. Furthermore, providing only relevant information to the user drastically reduces network bandwidth required for uploading and displaying marketing images or video as the quantity of marketing images or video needed to be browsed by the user is significantly less. Such reduction in network bandwidth enables use of digital commerce platform even on devices where availability of network bandwidth is a significant issue.

The present disclosure seeks to provide a method to increase conversion, or increase user engagement indicated by the length of time the user spends interacting with an online store, or increases the number of interactions, or increases the predicted lifetime value. Specifically, conversion relates to likelihood of a user of the online store making a purchase. Furthermore, the methods aims to increase the predicted lifetime value of a user by promoting behaviours that cause a better long term commercial relationship between the seller and user.

The present disclosure provides a computer-implemented method for requesting and transmitting marketing images or video. Specifically, the computer-implemented method relates to requesting data (such as, marketing images or video) and transmitting, in-response to the request, the marketing images or video. Notably, the marketing images or video provided using the method of the present disclosure are customized to the request and comprise information relevant to the request. Furthermore, the term “computer-implemented method” refers to methods whose implementation involves use of a computer, computer network, and other programmable apparatus associated with a digital system. Specifically, the computer-implemented method refers to a collection or a set of instructions executable by the computer or the digital system so as to configure the computer or the digital system to perform task that is the intent of the method. Optionally, the computer system and the digital system are adapted to allow for machine learning. Additionally, the computer-implemented method is intended to encompass such instructions stored in storage medium of the computer of the digital system, such as RAM, a hard disk, optical disk, or so forth, and is also intended to encompass “firmware” that is software stored on a ROM or so forth.

Optionally, the method is for producing and managing responsive online digital merchandising. Traditionally, an experience of online digital merchandising (such as e-commerce) is highly generic and does not provide a personalized experience to a user. The method of present disclosure seeks to provide responsive online digital merchandising, specifically an online digital merchandising experience that is customized to the user and is provided and managed in response to user input, data associated with the user and so forth. Beneficially, a personalized online digital merchandising experience tailored according to a user enables better user experience, increases customer retention and so forth.

The computer-implemented method for requesting and transmitting marketing images or video comprises the step of receiving a communication from a remote terminal. Notably, the communication received from the remote terminal refers to the request for marketing images or video. In other words, the communication is provided to enable transmitting of marketing images and video in-response thereto. Furthermore, remote terminal relates to a communication device at a remote location operable to transmit data communication for requesting the marketing images and video. Examples of the communication include, but are not limited to, electronic mail, instant messaging, multimedia text messaging. Furthermore, the remote terminal includes communication devices such as an online agent, an internet-enabled device or other internet enabled user equipment, or any future advancement thereof, or the like. Moreover, optionally, the remote terminal comprises a display for rendering the marketing images or video. In addition to the display, the remote terminal may optionally comprise a processor, a memory, and a transceiver.

Optionally, the communication from the remote terminal is received using a mobile network. As mentioned previously, the remote terminal provides data communication for requesting marketing images or video. Therefore, such communication is executed using the mobile network. The term “mobile network” refers to individual networks, or a collection thereof interconnected with each other and functioning as a single large network. Optionally, such mobile network is implemented by way of wired communication network, wireless communication network, or a combination thereof. It will be appreciated that physical connection is established for implementing the wired network, whereas the wireless network is implemented using a spectrum of at least one electromagnetic wave. Examples of such mobile network include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

Optionally, the remote terminal is a mobile device. Notably, the term “mobile device” refers to a portable computing equipment that comprises hardware, software, firmware, or a combination of these, with operative capability to transmit and receive communication. More optionally, the mobile device is a mobile phone, a smartphone or a tablet computer. In an example, the mobile device is a phablet or a personal digital assistant (PDA).

Optionally, the remote terminal is a laptop computer, a desktop computer, or a smart TV.

It will be appreciated that the communication from the remote terminal is received by a computing device such as a processor or a server, configured at a physically different location than the remote terminal. Furthermore, the computing device is operable to receive the communication from the remote terminal and initiate the process resulting in transmission of the marketing images or video to the remote terminal.

In an embodiment, the communication from the remote terminal includes user input. In an example, the communication from the remote terminal may be generated in response to a user input in form of the user using or launching an application programming interface (such as a mobile application) to view the marketing images or video. In another example, the user input comprises a search query provided by the user using an application programming interface (API), to view marketing images or video related to the search query. Therefore, in such example, the communication received from the remote terminal may comprise the user input in form of the search query.

The method further comprises the step of identifying a user, or a group of users, associated with the received communication. Notably, the communication received from the remote terminal comprises information relating to the user, or the group of users. Consequently, the user or the group of users are identified from the received communication. In other words, the communication received from the remote terminal comprises details related to the user, or the group of users to which the marketing images or video are to be transmitted. Therefore, such details are retrieved from the received communication.

In an embodiment, the step of identifying the user or the group of users associated with the received communication is performed using a database, or using one or more third party databases, or using a computer, or using computers on a network. The term “database” as used herein relates to an organized body of digital information regardless of the manner in which the data or the organized body thereof is represented. Optionally, the database may be hardware, software, firmware and/or any combination thereof. For example, the organized body of related data may be in the form of a table, a map, a grid, a packet, a datagram, a file, a document, a list or in any other form. Notably, the information related to the user, or the group of user is stored in the database, or in one or more third party databases. Consequently, upon receiving communication from the remote terminal, the information related to the user, or the group of users is retrieved from the database, or one or more third party databases. Additionally or alternatively, the user or the group of users associated with the received communication are identified using the computer or using computers on the network. Specifically, the computer or computers on the network are used for computation of the received communication to identify user, or the group of users associated therewith. It will be appreciated that identifying a user group doesn't require the identity of a user to be identified. For example, a user or user group could be identified by demographic/segmentation information without identifying a user.

The method further comprises the step of identifying data associated with the identified user or group of users. Specifically, the marketing images or video of goods or services are determined based on the data associated with the identified user or group of users. In other words, the marketing images or video are personalized according to the identified user or group of users based on the data associated therewith. Such data relates to characteristics, behaviour, activity (online and physical), of the user, and preferences of a user with respect to the marketing images or video of goods and services.

Optionally, the identified data associated with the identified user, or group of users, includes demographic information of the user, or group of users. Specifically, the demographic information of the user comprises information relating to age, gender, race, household income, occupation, place of residence of the user and the like. Beneficially, such demographic data assists in determining user preferences relating to the goods and services.

Optionally, the identified data associated with the identified user includes data from the interaction between the user and a store, or between the user and 3rd party systems, or between the user and a non-commerce site. As discussed above, the user accesses a plurality of application programming interfaces (APIs) on the computing device of the user. Furthermore, the user interacts with multiple physical entities such as individuals, organizations, physical stores and the like, using either the computing device thereof, in-person interactions or both. Notably, data from such interactions may provide numerous insights into user behaviour, preferences and opinions. Therefore, data from the interaction between the user and a store, or between the user and 3rd party systems, or between the user and a non-commerce site is identified. Furthermore, the identified data associated with the user includes data from the interaction between the user and the store, wherein the store is one or more of: an e-commerce store, a mobile commerce store, a social commerce store, a voice e-commerce store, or a physical store. The user interacts with a variety e-commerce stores (such as, Amazon®, eBay®), mobile commerce stores (such as Virgin®, Alcatel®), social commerce stores (such as Facebook®, Instagram®), voice e-commerce stores (such as Alexa®, Google Assistant®) or physical brick-and-mortar stores, and data from such interactions may be used to further determine goods or services best suited for the user. It will be appreciated that, in recent times with the widespread use of mobile devices (such as a mobile phone), interactions of the user with stores, third party systems or a non-commerce site (such as Whatsapp®) have a digital footprint in the mobile device. For example, data related to in-person interactions of the user for a commercial or non-commercial activity is stored in the mobile device in form of calendar appointments, payment receipts, text messages, web browsing activity and so forth. Therefore, data from such interactions may enable efficient profiling of the user to determine preferences related to goods and services of the user.

Optionally, the identified data associated with the identified user, or group of users, includes data from a blockchain relating to the user or group of users. The term “blockchain” refers to a distributed ledger consensually shared and synchronized in a decentralized form across a plurality of computing nodes. Optionally, such computing nodes are established across different locations and operated by different entities. Owing to the decentralized nature of the blockchain, the blockchain allows reliable and transparent recordal of the data. Pursuant to embodiments of the present disclosure, the user or the group of users may function as computing nodes in a blockchain, wherein the blockchain is operable to enable recordal of data therein, such as data comprising purchasing decisions, non-purchasing decisions, purchase return and other buying behaviours. Therefore, data from such blockchain is accessed to determine preferences related to goods and services of the user or the group of users.

Optionally, the identified data associated with the identified user or group of users includes a current weather or forecast weather. Notably, preferences of the user, or the group of users related to goods and services may vary based on the current weather and forecasted weather. In an example, the user may be interested in snow boots and thermal-lined jackets with the onset of winter and forecast of a snow storm. Therefore, based on the demographic data (such as location, age and gender), data related to the current weather and forecast weather in locale of the user can be obtained. Furthermore, data related to weather may comprise temperature conditions, humidity, wind conditions, precipitation, cloudiness, brightness, visibility, atmospheric pressure and so forth.

Optionally, the identified data associated with the identified user includes one or more of: a user look-up table or database; user data; information relating to a user's activity; social information. For instance, user data comprises user information obtained from the user or user's mobile device including identity or demographic information (for example age, race, gender, household income, occupation, place of residence). In addition, information relating to a user's activity comprises historic interaction between a user and the online store, between a user and third party systems such as information obtained from a third party store or a blockchain including purchasing decisions, non-purchasing decisions, purchase return and other buying behaviours. Furthermore, social information relates to information relating to a user's social group from third party social media databases, services or websites. It will be appreciated that the aforementioned data related to the user may be identified in tandem with each other, wherein data related to a particular type may influence another type of data. For example, information relating to the user's activity may be monitored and valued higher for a user in a younger demographic.

Optionally, the identified data associated with the identified user, or group of users, includes the physical activity of the user, or group of users. For instance, physical activity of the user or the group of user comprises real-life movements, location information, physical proximity of the a given user with respect to other users, social activity and status of users within the group of users. Furthermore, such physical activity of the user is monitored using mobile device of the user employing location-monitoring sensors (such as Global Positioning System), location triangulation using radio and cellular networks and so forth. Therefore, such data related to user is further associated with physical activity data of individuals in proximity to the user and determining whether the individuals proximate to the user are socially active with the user (determined using social networking platforms). Additionally, a physical activity level of the user may be determined using the mobile device of the user, such as average daily walking distance, number of calories are utilized and so forth.

Optionally, the identified data associated with the identified user, or group of users, includes the social and/or recreational activity of the user or group of users activities. For instance, the social or recreational activity of the user or group of users comprises geolocated social media activity (for example Facebook® check-ins) of a given user with respect to other users, social activity, known recreational habits, and status of users within a group of users.

Optionally, the method includes a step of updating a user look-up table or database or functions based on the communication received from the remote terminal. Specifically, the user look-up table or database comprises information to identify users associated with a given received communication. Therefore, with every received communication from the remote terminal, new users with the received communication may be identified and/or existing users may be disassociated from the received communication. In an example, the user look-up table or the database comprises information relating to user preferences in shoes. Specifically, according to the user look-up table or database, a user ‘A’ is interested in casual shoes and user ‘B’ is interested in formal shoes. In such example, according to a given received communication, an interest of the user ‘A’ in formal shoes is demonstrated. Consequently, in the user look-up table or database, interest of user ‘A’ is updated as formal and casual shoes.

The method further comprising the step of identifying goods or services, using the identified data associated with the identified user or group of users. Notably, the goods and service are identified based on data associated with the user or group of users and therefore, closely relate to preferences and interests of the user or the group of users. Such identified goods or services that closely relate to interests of users are significantly efficient in increasing user engagement and user retention on a platform for providing such goods and services. The data associated with the user provides substantial detail into preferences, characteristics, behaviour of the user with respect to commerce activities, and thus is used for accurate profiling of the user to identify targeted goods and services related to the user.

Optionally, identifying goods or services based on data from the interaction between the identified group of users and a store, or between the identified group of users and 3rd party systems. As mentioned previously, data related to the user or the group of users comprises data from the interaction between the user or the group of users and a store, or between the user and 3rd party systems, or between the user and a non-commerce site. Specifically, such data provides information relating to user's preference of goods and services based on user's prior purchases or browsing histories at the stores or third-party systems. Furthermore, such data is obtained using the mobile device of the user or mobile devices of the group of users. In an example, data from the interaction between the identified group of users and a given store indicates that the group of users prefers to purchase cotton scarves and hats on the onset of summers. Therefore, using such data from the interaction between the given store and the group of users, the goods or services identified related thereto may be summer-friendly accessories. It will be appreciated that although data from the interaction between the identified group of users and the store may indicate the user's (or the group's) interest in a particular good or service (as illustrated in the aforementioned example, cotton scarves and hats), the goods or services identified for the user (or the group) may be a broader subset of the particular good or service and may indicate general interest towards the particular category (as illustrated previously, summer-friendly accessories)

Optionally, identifying goods or services based on data relating to a store or a third party. Notably, the store or the third party may have information relating to user preferences based on certain user parameters or data (such as demographic data, weather data). Therefore, goods or services may be identified based on such information from the store or the third party.

Optionally, the data relating to the third party includes a current weather or forecast weather. In particular, data related to weather may comprise temperature conditions, humidity, wind conditions, precipitation, cloudiness, brightness, visibility, atmospheric pressure and so forth. As mentioned previously, preferences of the user, or the group of users related to goods and services may vary based on the current weather and forecasted weather. Therefore, such data related to current or forecast weather is used to identify goods or services. Herein, optionally, the identified goods or services include goods or services appropriate to other weather variations or properties of weather other than seasonal changes. Specifically, the interest in goods or services is generated or demonstrated with respect to variation in weather conditions or properties of weather rather than seasonal changes, for example daytime maximum temperature, humidity, precipitation, wind, hours of daylight, hours of sunshine or barometric pressure, individually or in any combination thereof. Therefore, goods and services corresponding to such weather variations or properties are identified. More specifically the interest in goods or services is generated or demonstrated with respect to the properties of the weather (past, current and forecast) local to the user, for example daytime maximum temperature, humidity, precipitation, wind, hours of daylight, hours of sunshine or barometric pressure, individually or in any combination thereof. More optionally, the properties of the weather include unusually hot weather, or unusually cold weather other than those variations typically expected due to seasonal changes in the user's locale. Optionally the interest in goods or services is generated or demonstrated with respect to the properties of the weather (past, current and forecast) not local to the user but of interest or relevance to the user.

Optionally, the identified goods or services correspond to a time of onset of a given season. More optionally, if a season is delayed, the identified goods or services include goods or services appropriate to the prolonged season, rather than to the delayed season. For instance, if spring comes late, the identified goods or services include long trousers, warm jackets and perhaps winter accessories. In another instance, if winter is delayed, the identified goods or services include goods or services related to autumn such as sale of pumpkin spice lattes, cotton jackets and scarves and so forth.

Optionally, identifying goods or services based on date and time; or time of day, or day of month, or month of year, or festivals and holidays, or past events or future events. In particular, user characteristics such as purchasing behaviour and spending limit, and user preference of goods and services are influenced by factors such as date and time; or time of day, or day of month, or month of year, or festivals and holidays, or past events or future events. For instance, spending limits for a user may experience a spike during festivals or holidays.

More optionally, identifying goods or services based on date and time; or time of day, or day of month, or month of year, or festivals and holidays, or past events or future events, in the locale of the identified user or group of users. Notably, user characteristics and user preferences are particularly influenced by festivals or holidays in local of the user of the group of the users. For instance, a user living in an eastern country such as Turkey may not experience a significant change in preferences or behaviour thereof due to Christmas. However in such instance, user preferences, characteristics and behaviour may change significantly around the festival of Ramadan. Similarly, user preferences are influenced by date and time; or time of day, or day of month, or month of year, in the locale of the identified user or group of users.

More optionally, identifying goods or services based on an electronic calendar of the identified user. Herein, the electronic calendar is retrieved from the mobile device of the identified user. Furthermore, the electronic calendar of the user may comprise important events specific to the user. Such important events may include birthdays, anniversaries, job interviews, planned holidays and the like. Therefore, such information from the electronic calendar of the identified user may be used to identify goods and services for the user.

More optionally identifying goods or services based on a combination of two or more sets of data. For example, data based upon an electronic calendar of the identified user may indicate the user is planning a holiday in Toronto on June 5^{th} and the forecasted weather in Toronto on June 5^{th} is indicated to be unseasonably hot. The combined data identifies relevant goods or services for the forecasted unusually hot weather in the users intended destination on the upcoming date.

Optionally, the identifying goods or services includes utilizing reinforcement learning algorithms to select goods or services to show to the user or to the group of users. The term “reinforcement learning algorithms” as used herein refers to a machine learning algorithms (for example, deep learning methods, deep convolutional neural methods) that take suitable actions or decisions in an environment to maximize some reward or minimize costs. It is employed herein to find the best possible behaviour or path in a specific situation. Herein, taking an action moves the environment or system from one state to another, and a reward is can be calculated based on a utility of the action. Notably, the reinforcement learning algorithms are sequence-based algorithms. In particular, a current output depends on a state of the current input and a next output depends on an output of the previous input. Optionally, the reinforcement learning algorithm is a multi-armed bandit algorithm. In other words, reinforcement learning algorithms aim at predicting multiple outputs and consequently, reward an output that was executed. Therefore, such machine learning algorithms are used to identify goods or services and then, further used to validate and train using the actions of the user.

Optionally, the identifying goods or services includes utilizing reinforcement learning algorithms to select goods or services to show to the user, or to the group of users, and to determine in which order to present the transmitted received marketing images or video. As aforementioned, reinforcement learning algorithms are used to identify goods and service and further learn and train based on the actions of the user. Similarly, the order in which the transmitted received marketing images or video are presented to the user is identified using such reinforcement learning algorithms and such order is further refined and validated based upon the action of the user.

Optionally, the reinforcement learning algorithms are multi-armed bandit algorithms, wherein each time a user, or a user from a particular group of users, visits a product page or purchases an item of a particular style category, a digital ‘reward token’ is created. Such digital reward token assist in learning and training of the system and produce significantly better learned and accurate predictions of goods and services. The multi-armed bandit algorithm, generally, dynamically allocates high traffic to methods that are performing well, while allocating less traffic to methods that are underperforming. It will be appreciated that the multi-armed bandit algorithm produces faster results since there is no need to wait for a single winning method. The term “multi-armed bandit” comes from a hypothetical experiment where a person must choose between multiple actions (i.e. slot machines, the “one-armed bandits”), each with an unknown pay-out. The goal is to determine the best or most profitable outcome through a series of choices. At the beginning of the experiment, when odds and pay-outs are unknown, the gambler must determine which machine to pull, in which order and how many times. This is the “multi-armed bandit problem”. In an example, a multi-armed bandit problem is when a website needs to determine which articles to display to a user, without any prior information about the user. The goal of the website goal is to maximize engagement, but they have many pieces of content from which to choose, and they lack data that would help them to pursue a specific strategy. Furthermore, the multi-armed bandit algorithm may be a Epsilon-Greedy algorithm for continuously balancing exploration with exploitation; an upper-confidence bound algorithm based on the Optimism in the Face of Uncertainty principle, and assumes that the unknown mean payoffs of each arm will be as high as possible, based on observable data; a Bayesian algorithm with randomized probability matching strategy and so forth.

Optionally, based on stored or calculated statistics of reward tokens, an automated learning agent module decides which cluster of goods or services in different styles to recommend to the user, or to the group of users. Notably, each of the cluster of goods or services in different styles is referred as an ‘arm’ (referring to the ‘arm’ in multi-armed bandit algorithm). Furthermore, a given cluster of goods or services in a given style is recommended to the user or to the group of users (namely, a ‘test’). Specifically, the term ‘test’ refers to recommending an item from the cluster of goods or service (namely, the ‘arm’) and analysing the response to the item. Therefore, the automated learning agent module employs stored or calculated statistics of reward token to determine the cluster of goods or services (namely, an ‘arm’) to be recommended to the user or the group of users. Herein, the automated learning module refers to a programmable component(s) configured using the aforementioned computing device and employing machine learning algorithms. As mentioned previously, each time a user visits a product page or purchases an item of a particular style category, a digital ‘reward token’ is created. Consequently, statistics of reward tokens such as number of rewards found, mean, standard deviation, and standard error of the mean and so forth are calculated or retrieved to determine the ‘arms’ to be recommended.

Optionally, the decision-making process uses one or more of:

(a) ‘Maximum’ reward token calculations, for example the mean reward for each bandit arm can be taken as the representative value;

(b) ‘Best’ choice policy: for example, applying a random from top-N policy;

(c) an exploration/exploitation mechanism, which dictates when the automated learning agent module tries to find out more information and when it tries to make use of prior result.

Optionally, the ‘maximum’ reward token calculation refers to a technique for decision-making (wherein decision refers to the choice of which ‘arm’ to be recommended to the user). Herein, mean reward for each bandit arm is designated as the representative reward for the arm, and the bandit arms with highest mean reward token return are recommended to the user. Specifically, the mean reward token return is calculated using historical data of users who were recommended the bandit arms. Alternatively, optionally, the decision-making processing uses ‘best’ choice policy. In particular, the ‘best’ choice policy comprises analysing reward token values of each of the bandit arms and choosing the bandit arms with highest reward token values. In an example, a random from top-5 policy is applied, wherein top-5 values of reward tokens are analysed and bandit arms with those top-5 reward token values are determined. Therefore, ‘best’ choice policy comprises analysing the calculated list of reward token values and selecting the arms with the highest N values and choosing between these at random. Alternatively, optionally, an exploration/exploitation mechanism, which dictates when the automated learning agent module tries to find out more information (exploration) and when it tries to make use of prior results (exploitation). The exploration/exploitation mechanism acquire new knowledge of the users and their response while maximizing their rewards using prior results. Specifically, the reward token values for bandit arms are analysed, while new bandit arms are also being recommended to the users to obtain new results. Therefore, marketing images or video relating to preferred merchandise and relating to new merchandising items are requested from the marketing images or video supplying system.

Optionally, a learning agent includes an exploration probability and an exploration decay parameter. Herein, exploration refers to exploring new bandit arms and analysing user response related thereto. The automated learning agent module is set up with an initial probability of exploration and a decay factor by which the exploration probability reduces over time. The automated learning agent module is set up with an initial probability of exploration (typically 1) and a decay factor by which the exploration probability reduces over time. Such approach functions as a type of learning rate; the higher the learning rate is, the sooner the automated learning agent will stop exploring and start near-exclusively exploiting. Herein, by an effective use of reinforcement learning algorithms the inventive method is capable of dynamically capturing the preference of a single user/user group in real time and provide an optimized display environment for a particular user based upon that users behaviour and characteristics.

Optionally, identifying the goods or services includes using data not associated with the identified user. Notably, a variety of factors unrelated to the user may influence the user's preference in terms of goods and services. Consequently, such factors are taken into account to obtain a wider view of user's preference in terms of goods and services.

Optionally, the data not associated with the identified user includes one or more of: chronological data; environmental data; geographical data; group user data; social information; platform specific data; merchandise specific data; competitor data or supply chain data. Herein, chronological data refers to data related to date and time, local holidays, festivals and the like; environmental data refers to data related to temperature, weather, climate, humidity, precipitation, in the locale of the identified user; geographical data refers to data related to a particular location. Furthermore, group user data includes data related to historic interaction between other users, or between groups of users and the online store, between other users or groups of users and third party systems such as information obtained from a third party store or a blockchain including purchasing decisions, non-purchasing decisions, purchase return and other buying behaviour. Moreover, social information comprises news or current affair related information; platform specific data refers to information relating to the functionality, style or preferences of the online store for example online store image styles. In addition, merchandise specific data comprises information relating to a specific product or group of products; competitor data includes information relating to pricing or promotions of merchandise; and supply chain data comprises data related to availability, stock levels, supply related blockchains and provenance.

It will be appreciated that the identified goods or services are identified by those most likely to increase user conversion, user engagement and/or predicted lifetime value between the seller and buyer. For example, the goods and services are identified based on a user look-up table or database or functions (for example historic user buying activity). Herein, user conversion refers to likelihood of a user of the online store making a purchase.

Optionally, the goods or services are identified responsive to the user input. As mentioned previously, the user input may be in form of user using or launching an application programming interface or providing a search query. Therefore, the identified goods or services are responsive to the application programming interface or the search query. In an example, the goods or services may be identified based on a type of application programming interface. For instance, the application programming interface relates to a mobile application may be for an online shoe store. Therefore, the identified goods responsive to the user input may be shoes. In another example, the goods or services may be identified based on the search query provided by the user using the application programming interface. For instance, the user provides a search query ‘men's shirts’ using an application programming interface relating to an online commerce store. Therefore, the identified goods or services responsive to the user input may be different types of shirts.

Optionally, the identified goods or services include garments. In particular, the garments include aprons, belt, bodices, drawers, garters, gloves, hoods, masks, nightdresses, pinafores, shirts, skirts, ties, trousers, waistcoats, watches, t-shirts, dresses, accessories, shoes, socks, shorts and so forth.

Optionally, the garments are suitable for the user. Specifically, the identified goods or services include garments is preferred by the user. It is to be understood that the garments preferred by the user comprise a style, fit, cost factors that are preferred by the user. Furthermore, preference of the user may vary based on factors unrelated to the user such as weather, season, time of the month, previous purchases and so forth. Therefore, the method for identification of goods and services for the identified user takes into account such factors and thus recommends garments that are suitable for the user.

Optionally, identified data associated with the identified user includes user viewing preferences, for example if they prefer to see clothes on a model close to their own body shape, or to see clothes on standard sized models, or to see clothes on models in certain poses, or to see clothes on headless models, or to see clothes on ghost mannequins. Notably, such data is identified using historical data related to purchases of the user. Specifically, from the historical data of the user, the size, fit, length and such factors may be ascertained. For instance, in prior purchases of the user, the user may have purchased a garment which was shown to the user on a standard sized model. Therefore, from such prior purchase, the viewing preference of the user may be identified.

In an embodiment, if the identified data associated with the identified user is that the user prefers to see clothes on a model close to their own body shape, then the identified goods or services include clothes displayed on a model close to their own body shape. Similarly, if the identified data associated with the identified user is that the user prefers to see clothes on standard sized models, then the identified goods or services include clothes displayed on standard sized models.

The method further comprises the step of requesting marketing images or video from a marketing images or video supplying system, relating to the identified goods or services. Herein, the marketing images or video relating to the identified goods or services are requested. Specifically, the identified goods or services are offered to the user for purchase thereof. Consequently, marketing images or video relating to the identified goods or services are obtained, for transmission to the user. It will be appreciated that the goods or services identified for the user are based on user's preferences, behaviour, characteristics and so forth. Therefore, the marketing images or video relating to the identified goods or services also relate to user's viewing preferences. Furthermore, the marketing images or video supplying system is operable to provide the marketing images or video relating goods and services upon receiving the requesting therefor.

Optionally, the requested marketing images or video include photographs or video of products on their own, or in combinations, or on a mannequin, or hanging on their own or being worn by a model, or being worn on a computer-generated image of a model, or being worn on a computer-generated image of the user, or being worn on a model that is entirely computer generated, or being worn on a model image that is partially computer generated. Herein, the identified goods or services include garments and therefore, the marketing images or video include photographs or video of garments either on their own or in combinations (such as outfits worn by a model or a mannequin) or both. The requested marketing images or video are generated in a manner that the essential components of the product (herein, garment) displayed therein are captured efficiently and accurately represent the product. Furthermore, a clear and accurate marketing image or video relating to the identified goods or services helps increase user conversion and engagement with the online platform.

Optionally, the marketing images or video supplying system includes a computer system for automatically generating marketing images or video, or a database of pre-produced marketing images or video. Specifically, the computing system relates to a processing unit operable to generate marketing images or video. Furthermore, the computer system comprises a display, a processor, a memory, a transceiver. Additionally, optionally, the computer system or the database are integral to the remote terminal. In an instance the computer system or the database is integral to the remote terminal, the request for the marketing images or video is sent from the remote terminal to the computer system or database and in-response the computer system or database transmits the marketing images or video. In such instance, the computation for identifying the user or the group of users and identifying data related to the identified user or the group of user is also performed on the computer system or the database. Furthermore, the database of pre-produced marketing images or video relates to an information repository comprising marketing images or video corresponding to various identified goods and services for the identified user or the group of users. Herein, the marketing images or video may be shot using a photo-camera or may be composed digitally using computer graphics or a combination of both. Additionally, the database may comprise marketing images or video prior to processing thereof, wherein the pre-processed marketing images or video may be processed using the computer system to obtain the marketing images or video.

Optionally, the marketing images or video supplying system constructs the requested marketing images or video dynamically. Specifically, the marketing images or video supplying system dynamically captures the user's preferences using the identified data associated with the user and the identified goods or services and provides an optimized display environment for the user to view such marketing images or video. Furthermore, the marketing images or video supplying system is operable to analyse identified goods or services associated with the identified user and thereafter, dynamically construct marketing images or video based on the identified goods or services.

Optionally, the identified goods or services includes a style label of relevant merchandising. Notably, term style label refers to features associated identified goods. Optionally, such features relating to the identified goods may be stored in an external database. In an example, the method maps features associated with each of the identified goods to identify a set of common features, wherein the common features form the style label for the identified goods. Examples of the style label include, but are not limited to, colour of identified goods, style of identified goods, size of the identified goods, models depicted in identified goods, a body pose of models depicted in identified goods, a background setting of images relating to identified goods, a light adaptation of images relating to identified goods, a material of identified goods.

Optionally, the method includes the step of marketing images or video supplying system producing marketing images or video matching the style label. Subsequently, upon identifying style labels associated with the identified goods, the marketing images or video supplying system produces marketing images or video matching the style label. In an example, the identified style label may include ‘red’ and ‘shirt’. In such case, the method may produce red shirts from a plurality of brands for marketing thereof. More optionally, the marketing images or video matching the style label are produced dynamically in real time based on parameters identified by the system. In such case, the produced marketing images or video may be stored and retrieved (cached) in the marketing images or video supplying system, or in an external cache to improve efficiency in case of other requests of same or similar style labels.

Optionally, the received requested marketing images or video from the marketing images or video supplying system are those with a closest match to the style label. It will be appreciated that the method will operate to provide marketing images and video that closely match the style labels of the identified good. Beneficially, providing marketing goods that closely match the style label enhances user-experience and further enables targeted merchandising to users, thereby increasing profitability of online commerce platforms.

In an embodiment, the method includes the step of the marketing images or video supplying system producing marketing images or video matching the style label using a computer generated image rendering technique. Herein, computer generated image refers to a digitally create photorealistic image using graphics software tools on a computer system. Specifically, computer generated images eliminate requirement of a model for presenting the identified goods or services (for example, garments) and provide flexibility in adjusting the style label, model characteristics, features of the identified goods or services and the like. Furthermore, such computer generated images (CGI) are rendered to obtain marketing images relating to identified goods or services.

In another embodiment, the method includes a step of the marketing images or video supplying system producing marketing images or video matching the style label using a technique of automated 2D composed model photography, using synthesis from an undressed model photograph of a model in a body pose and in a camera view matching a style requirement, and one or more garment photos digitized on a mannequin. Notably, the method employs composed model photography technique for automated generation of the marketing images or video. Specifically, in such case, the method obtains a digital image of the model (namely, the undressed model photograph). Such undressed model photograph is obtained on the basis of the body pose (for example, posture, position, and so forth) of the model and the camera view (for example, camera facing front of the model, camera facing back of the model, camera facing side of the model, and so forth) matching the style requirement for generation of the marketing images or video. Additionally, one or more digital images of garments (namely, the one or more garment photos) are obtained, wherein the one or more garment photos are digitized on the mannequin. In an example, the one or more garment photos comprise a digital image in which the mannequin is wearing a first garment and a second garment. Subsequently, the digitized one or more garment photos (namely, the first garment and the second garment) are digitized and further overlaid onto the undressed model photograph for generation of the automated composed model photograph.

Optionally, the requested marketing images or video from the marketing images or video supplying system are marketing images, and in which the marketing images are generated using image processing to enhance the overall photorealism by implementing a deep neural network (e.g. cascade refinement network or generative adversarial networks) to provide one or more of: additional shadow; creases; scene background and setting; animation, or lighting adaption. Specifically, the deep neural network employs machine learning algorithms. Typically, the machine learning algorithms refer to a category of algorithms employed by the one or more software applications that allows the one or more software applications to become more accurate in predicting outcomes and/or performing tasks, without being explicitly programmed. Typically, the one or more software applications are a set of instructions executable by the deep neural networks so as to configure the computer-implemented method to generate photorealistic changes associated with the digital image. Specifically, the machine learning algorithms are employed to artificially train the software applications so as to enable them to automatically learn, from analysing training dataset and improving performance from experience, without being explicitly programmed.

More optionally, the deep neural network operates to generate photorealistic changes for the marketing images or to enhance the overall photorealism of the marketing images. The photorealistic changes may include, for example, additional shadow; creases; scene background and setting; animation, or lighting adaption.

According to one embodiment, generative adversarial network (GAN) is employed for generation of the photorealistic changes or enhancement of overall photorealism of the marketing images. It will be appreciated that the generator-adversarial network is implemented by way of a generator neural network and a discriminator neural network. Moreover, the generator neural network, employing generative algorithms, is operable to create new data instances for training thereof. In other words, the generator neural network creates random photorealistic changes by analysing features relating to images for training. Furthermore, the discriminator neural network employing discriminative algorithms evaluate the new data instances. In other words, the discriminator neural networks analyse the random photorealistic changes so as to, for example, assign a similarity score to them. Subsequently, the GAN is trained to produce photorealistic changes for the marketing images.

According to another embodiment, cascade refinement network (CRN) is employed for generation of the photorealistic changes or enhancement of overall photorealism of the marketing images. Optionally, the deep neural networks include a modified and repurposed version of the cascade refinement network (CRN). It will be appreciated that the CRN is implemented using machine learning algorithms. Specifically, the cascade refinement network is implemented by way of a plurality of convolution layers connected by way of a cascade connection. Furthermore, the CRN is trained using low-resolution images and high-resolution images for generation of photorealistic changes. Subsequently, the CRN is trained to produce photorealistic changes for the marketing images, wherein photorealistic changes for a marketing image produced by a first convolution layer of the CRN is refined by a second layer, and so on. Therefore, a highest convolution layer of the CRN produces enhanced marketing images with photorealistic changes.

Optionally, the method includes the step of the marketing images or video supplying system producing marketing images or video including the step of an automated machine-learning-powered system performing the steps of:

(a) cutting out garment textures from garment photos using an image segmentation or alpha matting algorithm;

(b) warping these cut-out garment textures to match the body shape and pose of a model; and

(c) overlaying the garment textures onto the undressed model photos.

Optionally, in this regard, the image segmentation or alpha matting algorithm relate to image processing techniques employed to isolate segments of image therefrom. Specifically, alpha matting algorithm relates to image processing algorithm used to softly extracting foreground from an image. Therefore, such technique are efficiently utilized to cut-out (namely, extract) garment textures from garment photos. Furthermore, the image processing techniques are based on a deep convolutional neural network such as DeepLab. It is to be understood that garment texture are extracted from a standard set of photos of a garment (wherein the set of photos comprises at least one photo of the garment) and then further processed to obtain a photorealistic image, that complies with user's viewing preference of identified goods or services (herein, garments). Subsequently, these cut-out garment textures warped to match the body shape and pose of a model. Herein, the model refers to a model that matches the viewing preferences of the user and thus, cut-out garment textures are warped to match such model to obtain a photorealistic image. It will be appreciated that the garment photos from which the garment textures are extracted are a standard set of photos and comprise the garment in only a particular given orientation and shape and thus the garment texture has to be adjusted according to the model. Therefore, the cut-out garment textures are warped to match the body-shape and pose of the model. In an example, the cut-out garment texture is in a straight position and is cut out from a model of standard size. However in such example, the model that matches the viewing preferences of the user has a leaner body and thus the garment needs to be adjusted accordingly. Furthermore, the model is in a tilted position. Therefore in such example, the cut-out garment is warped to seemingly fit the body shape of the leaner model and match the tilted position. Moreover, the cut-out garment textures are warped by defining transformation templates for each body pose of the model.

Furthermore optionally, in the aforementioned regard, the garment textures are overlaid onto the undressed model photos. It will be appreciated that marketing images and video supplying system comprises a database storing photos of a plurality of undressed models, wherein photos of each of the plurality of undressed models vary in factors relating to appearance (for example, skin colour, height, body type, hair styles and the like). Therefore the model with the factors matching user's viewing preferences is selected. Subsequently, undressed (namely, unclothed) photos of such model are selected to be overlaid with warped cut-outs of the garment textures to obtain the marketing images or video for identified goods or services.

It will be appreciated that the image processing and production techniques discussed here have been explain with respect to images for the sake of simplicity and should not unduly limit the scope of the claims. A person skilled in the art will recognize many variations, alternatives, and modifications of embodiments of the present disclosure and their application to video processing and production techniques.

Optionally, the requested marketing images or video from the marketing images or video supplying system are marketing images, and in which the marketing images are obtained from a database of prerendered merchandise images. Specifically, the database comprises prerendered images of the merchandise stored therein, wherein the database comprises prerendered images according to a plurality of identified goods or services. Therefore, from the data associated with the user and the, the goods or services are identified and prerendered images related thereto are provided to the remote terminal.

The method further comprises the step of receiving the requested marketing images or video from the marketing images or video supplying system. Notably, the marketing images or video are received from the marketing images or video supplying system in response to the request for the marketing images or video. Herein, the marketing images or video are received for subsequent transmission to the remote terminal.

Optionally, the received marketing images or video include 2D images or 3D images. More optionally, the received marketing images or video include two-dimensional and three-dimensional images. Herein, the two-dimensional image refers to an image captured by an imaging device (such as a camera) or generated using a computer comprising two dimensions (namely, the length and the breadth). Furthermore, the three-dimensional image may be a depth image or a three-dimensional model projected into an image with two-dimensional texture. Furthermore, techniques employed for generation of such three-dimensional images may include, but are not limited to, depth image prior, UV Mapping. Such three-dimensional image provides a perception of depth, even when rendered on a two-dimensional display arrangement.

Optionally, the received marketing images or video include augmented reality content or virtual reality content. Herein, the term “virtual reality” refers to a simulated environment comprising virtual objects (namely, computer-generated objects), whereas the term “augmented reality” refers to a simulated environment comprising virtual objects overlaid on a real-world environment. As an example, a given received marketing video may comprise virtual reality advertisement content for a product. Notably, the virtual reality content or the augmented reality content allows for providing immersive marketing-related information to a user, thereby enhancing the user's engagement with the received marketing images or video. As an example, a given received marketing video may comprise virtual reality advertisement content for a product.

The method further includes transmitting the received marketing images or video to the remote terminal. Herein, the received marketing images or video transmitted to the remote terminal are in accordance with the preferences of the user associated with the mobile terminal.

Optionally, the transmitting of the received marketing images or video to the remote terminal includes using the mobile network. Herein, the computing device (such as a processor or a server) employed for identifying user, data associated with the user, and producing marketing images or video is configured at a different location than the remote terminal. Thus, the mobile network is employed for transmission of marketing images or video to the remote terminal.

Optionally, the method further includes the step in which rendition of the received marketing images or video is performed on the remote terminal. As mentioned previously, the remote terminal comprises a display for rendering the received marketing images or video, thereby enabling the user of the remote terminal to view the marketing images or video. Examples of the display include, but are not limited to, a Cathode Ray Tube (CRT)-based display, a Liquid Crystal Display (LCD), a Light Emitting Diode (LED)-based display, a micro LED-based display, an Organic LED (OLED)-based display, a micro OLED-based display, a Liquid Crystal on Silicon (LCoS)-based display.

Optionally, the transmitting the received marketing images or video to the remote terminal includes optimisation of the configuration of the received marketing images or video, prior to transmitting marketing images or video in an optimized configuration. In particular, the optimisation herein refers to adjustment of the received marketing images or video according to specifications (such as display size, display type, aspect ratio, processing speed and the like) of the remote terminal. Specifically, the specifications of the remote terminal are obtained prior to the transmission to optimise the received marketing images or video according to the remote terminal. More specifically, the received marketing images or video are optimised to obtain an improved viewing experience by the user on the remote terminal. In an example, an aspect ratio of the received marketing images or video is 16:9. However in such example, the aspect ratio of the display of the remote terminal is 18:9. Therefore, the received marketing images or video are optimised to match the aspect ratio of the display of the remote terminal.

Optionally, the step of transmitting the received marketing images or video to the remote terminal is performed by an online website store. In other words, the received marketing images or video are provided to the remote terminal by the online website store. Herein, the online website store is in charge for the sale of the identified goods and services. Therefore, the online website store provides the marketing images or video according to the viewing preferences of the user for sale of the identified goods or services thereof. It will be appreciated that the steps of identifying the user, identifying data associated with the user, identifying goods or services using the identified data and so forth may optionally be performed by the online website store. Examples of the online website store include, but are not limited to, Amazon®, Walmart®, Best Buy®, Nordstorm®, eBay®, Alibaba®.

Optionally, the step of transmitting the received marketing images or video to the remote terminal is performed using one or more of: electronic mail, instant messaging, multimedia text messaging, an online agent or mobile station, an internet-enabled device or other internet enabled user equipment, or any future advancement thereof.

Optionally, the method further includes the step of automatically producing and presenting visual merchandising in response to predetermined, predicted or learned criteria. Herein specifically, the data associated with the identified user is analysed and the viewing preferences of the user (including user characteristics, behaviour, purchasing patterns) are stored using the computing device. Furthermore, the merchandise is produced and presented to the user using the predetermined, predicted or learned criteria that is in accordance with the viewing preferences of the user. Optionally, machine learning algorithms are employed for prediction and/or learning of the criteria related to the user and present visual merchandise relating to the preferences thereof.

Optionally, the step of storing the marketing images or video received from the marketing images or video supplying system. Herein, the marketing images or video are stored in a database for future use. Specifically, the marketing images or video may be provided to the user in a future instance of receiving a similar or related communication (namely, request for marketing images or video) and thereafter, the stored images or video are provided to the user.

In a second aspect, an embodiment of the present disclosure provides a computer program product executable on a processor to:

(i) receive a communication from a remote terminal;

(ii) identify a user, or a group of users, associated with the received communication;

(iii) identify data associated with the identified user or group of users;

(iv) identify goods or services, using the identified data associated with the identified user or group of users;

(v) request marketing images or video from a marketing images or video supplying system, relating to the identified goods or services;

(vi) receive the requested marketing images or video from the marketing images or video supplying system, and

(vii) transmit the received marketing images or video to the remote terminal.

The present description also relates to the computer program product as described above. The various embodiments and variants disclosed above apply mutatis mutandis to the computer program product.

Throughout the present disclosure, the term “processor” refers to a computational element that is operable to respond to and processes instructions that drive the system or the computer program product. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the system.

Optionally, the computer program product is further executable on the processor to perform the aforementioned method of requesting and transmitting marketing images or video.

In a third aspect, an embodiment of the present disclosure provides a system including a processor and a marketing images or video supplying system, wherein the processor is configured to:

(i) receive a communication from a remote terminal;

(ii) identify a user, or a group of users, associated with the received communication;

(iii) identify data associated with the identified user or group of users;

(iv) identify goods or services, using the identified data associated with the identified user or group of users;

(v) request marketing images or video from the marketing images or video supplying system, relating to the identified goods or services;

(vi) receive the requested marketing images or video from the marketing images or video supplying system, and

(vii) transmit the received marketing images or video to the remote terminal.

The present description also relates to the system as described above. The various embodiments and variants disclosed above apply mutatis mutandis to the system.

Optionally, the system includes the remote terminal.

Optionally, the system or the processor is configured to perform the aforementioned method for requesting and transmitting marketing images or video.

In a fourth aspect, an embodiment of the present disclosure provides a computer-implemented method for producing and managing responsive online digital merchandising, including identifying goods or services using identified data associated with an identified user in communication from a remote terminal; receiving requested marketing images or video from a marketing images or video supplying system, and transmitting the received marketing images or video to the remote terminal.

The present description also relates to the method as described above.

The various embodiments and variants disclosed above apply mutatis mutandis to the method.

Optionally, the method for producing and managing responsive online digital merchandising includes the aforementioned method for requesting and transmitting marketing images or video.

In a fifth aspect, an embodiment of the present disclosure provides a computer program product executable on a processor to perform a method for producing and managing responsive online digital merchandising.

In a sixth aspect, an embodiment of the present disclosure provides a system for producing and managing responsive online digital merchandising, the system including a processor and a marketing images or video supplying system, the processor configured to identify goods or services using identified data associated with an identified user in communication from a remote terminal; to receive requested marketing images or video from the marketing images or video supplying system, and to transmit the received marketing images or video to the remote terminal.

The present description also relates to the system as described above. The various embodiments and variants disclosed above apply mutatis mutandis to the system.

Optionally, the system includes the remote terminal.

Optionally, the system or the processor is configured to perform a method of requesting and transmitting marketing images or video, or method for producing and managing responsive online digital merchandising.

In a seventh aspect, an embodiment of the present disclosure provides a computer-implemented method for requesting and displaying marketing images or video, the method including the steps of:

(i) identifying a user of a terminal;

(ii) identifying data associated with the identified user;

(iii) identifying goods or services, using the identified data associated with the identified user;

(iv) requesting marketing images or video from a marketing images or video supplying system, relating to the identified goods or services;

(v) receiving the requested marketing images or video from the marketing images or video supplying system, and

(vii) displaying the received marketing images or video on the terminal.

The present description also relates to the method as described above. The various embodiments and variants disclosed above apply mutatis mutandis to the method.

Optionally, the marketing images or video supplying system is included in the terminal.

Optionally, the terminal is a mobile device e.g. a mobile phone or a tablet.

In an eighth aspect, an embodiment of the present disclosure provides a computer program product executable on a processor to:

(i) identify a user of a terminal;

(ii) identify data associated with the identified user;

(iii) identify goods or services, using the identified data associated with the identified user;

(iv) request marketing images or video from a marketing images or video supplying system, relating to the identified goods or services;

(v) receive the requested marketing images or video from the marketing images or video supplying system, and

(vi) display the received marketing images or video on the terminal.

The present description also relates to the computer program product as described above. The various embodiments and variants disclosed above apply mutatis mutandis to the computer program product.

Optionally, the computer program product is further executable on the processor to perform a method of requesting and displaying marketing images or video.

In a ninth aspect, an embodiment of the present disclosure provides a terminal including a processor and a marketing images or video supplying system, wherein the processor is configured to:

(i) identify a user of the terminal;

(ii) identify data associated with the identified user;

(iii) identify goods or services, using the identified data associated with the identified user;

(iv) request marketing images or video from the marketing images or video supplying system, relating to the identified goods or services;

(v) receive the requested marketing images or video from the marketing images or video supplying system, and

(vi) display the received marketing images or video on the terminal.

The present description also relates to the system as described above. The various embodiments and variants disclosed above apply mutatis mutandis to the system.

Optionally, the terminal is a mobile device e.g. a mobile phone or a tablet.

### DETAILED DESCRIPTION OF THE DRAWINGS

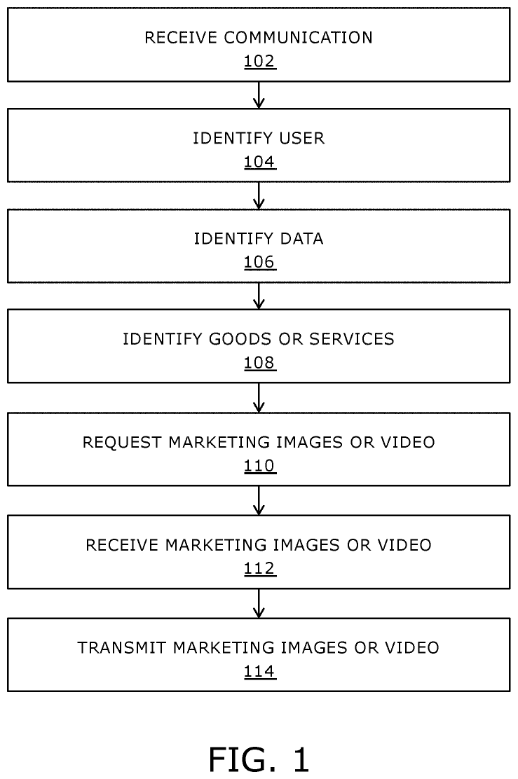

Referring to FIG. 1, there is shown an illustration of steps of a computer-implemented method 100 for requesting and transmitting marketing images or video, in accordance with an embodiment of the present disclosure. At a step 102, a communication from a remote terminal is received. At a step 104, a user, or a group of users, associated with the received communication is identified. At a step 106, data associated with the identified user or group of users is identified. At a step 108, goods or services are identified using the identified data associated with the identified user or group of users. At a step 110, marketing images or video relating to the identified goods or services are requested from a marketing images or video supplying system. At a step 112, the requested marketing images or video are received from the marketing images or video supplying system. At a step 114, the received marketing images or video are transmitted to the remote terminal.

The steps 102, 104, 106, 108, 110, 112 and 114 are only illustrative and other alternatives can also be provided where one or more steps are added, one or more steps are removed, or one or more steps are provided in a different sequence without departing from the scope of the claims herein.

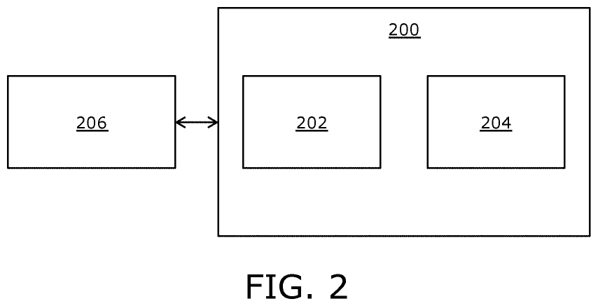

Referring to FIG. 2, there is shown a block diagram of a system 200 for requesting and transmitting marketing images or video, in accordance with an embodiment of the present disclosure. The system 200 includes a processor 202 and a marketing images or video supplying system 204. The processor is configured to receive a communication from a remote terminal 206 and transmit the received marketing images or video to the remote terminal 204.

FIG. 2 is merely an example, which should not unduly limit the scope of the claims herein. It is to be understood that the simplified illustration of the system 200 for requesting and transmitting marketing images or video is provided as an example and is not to be construed as limiting the system 200 to specific numbers, types, or arrangements of the database, and the processing arrangement. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method for requesting and transmitting marketing images or video, the method including the steps of:
(i) receiving a communication from a remote terminal;
(ii) identifying a user, or a group of users, associated with the received communication;
(iii) identifying data associated with the identified user or group of users;
(iv) identifying goods or services, using the identified data associated with the identified user or group of users;
(v) requesting marketing images or video from a marketing images or video supplying system, relating to the identified goods or services;
(vi) receiving the requested marketing images or video from the marketing images or video supplying system; and
(vii) transmitting the received marketing images or video to the remote terminal.

2. The computer-implemented method of claim 1, including a step of storing the marketing images or video received from the marketing images or the video supplying system.

3. The computer-implemented method of claim 1, wherein the remote terminal is a mobile device, and wherein the steps (i) and (vii) include using a mobile network.

4-7. (canceled)

8. The computer-implemented method of claim 1, wherein the requested marketing images or video include photographs or videos of products on their own, or in combinations, or on a mannequin, or hanging on their own or being worn by a model, or being worn on a computer-generated image of a model, or being worn on a computer-generated image of the user, or being worn on a model that is entirely computer generated, or being worn on a model image that is partially computer generated.

9. The computer-implemented method of claim 1, (a) including a step of automatically producing and presenting visual merchandising in response to predetermined, predicted or learned criteria; or
(b) in which the identified data associated with the identified user, or group of users, includes demographic information of the user, or group of users; or
(c) in which the identified data associated with the identified user includes data from an interaction between the user and a store, or between the user and 3rd party systems, or between the user and a non-commerce site.

10-13. (canceled)

14. The computer-implemented method of claim 1, in which the identified data associated with the identified user, or group of users, includes data from a blockchain relating to the user or group of users.

15. (canceled)

16. The computer-implemented method of claim 1, including identifying goods or services based on data relating to a store or a third party, in which the data relating to the third party includes a current weather or forecast weather.

17. (canceled)

18. The computer-implemented method of claim 1, in which the identified data associated with the identified user or group of users includes a current weather or forecast weather.

19. The computer-implemented method of claim 1, (a) including identifying goods or services based on date and time; or time of day, or day of month, or month of year, or festivals and holidays, or past events or future events; or
(b) including identifying goods or services based on date and time; or time of day, or day of month, or month of year, or festivals and holidays, or past events or future events, in the locale of the identified user or group of users; or
(c) including identifying goods or services based on an electronic calendar of the identified user; or
(d) in which the transmitting the received marketing images or video to the remote terminal includes optimisation of the configuration of the received marketing images or video, prior to transmitting marketing images or video in an optimized configuration, e.g. for display on a screen of the remote terminal.

20-22. (canceled)

23. The computer-implemented method of claim 1, in which the identifying goods or services includes utilising reinforcement learning algorithms to select goods or services to show to the user or to the group of users; or
in which the identifying goods or services includes utilising reinforcement learning algorithms to select goods or services to show to the user, or to the group of users, and to determine in which order to present the transmitted received marketing images or video.

24. (canceled)

25. The computer-implemented method of any of claim 1, in which the identifying goods or services includes utilizing reinforcement learning algorithms to select goods or services to show to the user or to the group of users, and in which the reinforcement learning algorithms are multi-armed bandit algorithms, wherein each time a user, or a user from a particular group of users, visits a product page or purchases an item of a particular style category, a digital ‘reward token’ is created.

26-30. (canceled)

31. The computer-implemented method of claim 1, in which the identified goods or services include goods or services appropriate to properties of the weather (past, current and forecast) local to the user.

32-34. (canceled)

35. The computer-implemented method of claim 1, in which identified data associated with the identified user includes user viewing preferences, for example if they prefer to see clothes on a model close to their own body shape, or to see clothes on standard sized models, or to see clothes on models in certain poses, or to see clothes on headless models, or to see clothes on ghost mannequins.

36. The computer-implemented method of claim 35, in which if the identified data associated with the identified user is that the user prefers to see clothes on a model close to their own body shape, then the identified goods or services include clothes displayed on a model close to their own body shape; or
in which if the identified data associated with the identified user is that the user prefers to see clothes on standard sized models, then the identified goods or services include clothes displayed on standard sized models.

37-48. (canceled)

49. The computer-implemented method of claim 1, in which the identified goods or services includes a style label of relevant merchandising.

50. The computer-implemented method of claim 49, (a) including the step of the marketing images or video supplying system producing marketing images or video matching the style label; or
(b) in which the received requested marketing images or video from the marketing images or video supplying system are those with a closest match to the style label; or
(c) including the step of the marketing images or video supplying system producing marketing images or video matching the style label using a computer-generated image rendering technique; or
(d) including the step of the marketing images or video supplying system producing marketing images or video matching the style label using a technique of automated 2D composed model photography, using synthesis from an undressed model photograph of a model in a body pose and in a camera view matching a style requirement, and one or more garment photos digitised on a mannequin.

51-53. (canceled)

54. The computer-implemented method of claim 1, including the step of the marketing images or video supplying system producing marketing images or video including a step of an automated machine-learning-powered system performing steps of:
(a) cutting out garment textures from garment photos using an image segmentation or alpha matting algorithm;
(b) warping these cut-out garment textures to match the body shape and pose of a model; and
(c) overlaying the garment textures onto the undressed model photos.

55. The computer-implemented method of claim 1, in which the requested marketing images or video from the marketing images or video supplying system are marketing images, and in which the marketing images are generated using image processing to enhance the overall photorealism by implementing a deep neural network to provide one or more of: additional shadow; creases; scene background and setting; animation, or lighting adaption.

56-62. (canceled)

63. The computer-implemented method of claim 1, in which the received marketing images or video include augmented reality content or virtual reality content.

64. A computer program product embodied on a non-transitory storage medium, the computer program product executable on a processor to:
(i) receive a communication from a remote terminal;
(ii) identify a user, or a group of users, associated with the received communication;
(iii) identify data associated with the identified user or group of users;
(iv) identify goods or services, using the identified data associated with the identified user or group of users;
(v) request marketing images or video from a marketing images or video supplying system, relating to the identified goods or services;
(vi) receive the requested marketing images or video from the marketing images or video supplying system; and
(vii) transmit the received marketing images or video to the remote terminal.

65. (canceled)

66. A system including a processor and a marketing images or video supplying system, wherein the processor is configured to:
(i) receive a communication from a remote terminal;
(ii) identify a user, or a group of users, associated with the received communication;
(iii) identify data associated with the identified user or group of users;
(iv) identify goods or services, using the identified data associated with the identified user or group of users;
(v) request marketing images or video from the marketing images or video supplying system, relating to the identified goods or services;
(vi) receive the requested marketing images or video from the marketing images or video supplying system; and
(vii) transmit the received marketing images or video to the remote terminal.

67-81. (canceled)
